(19) United States
(12) Patent Application Publication
(10) Pub. No.: US 2025/0347586 A1
(43) Pub. Date: Nov. 13, 2025

(54) LENS ARRAYS, FIBER OPTIC FIXTURES THAT INCLUDE THE LENS ARRAYS, PROBE SYSTEMS THAT INCLUDE THE FIBER OPTIC FIXTURES, AND METHODS OF FORMING FIBER OPTIC FIXTURES

(71) Applicant: FormFactor, Inc., Livermore, CA (US)

(72) Inventors: Quan Yuan, Dublin, CA (US); Eric Robert Christenson, Tualatin, OR (US); Daniel Rishavy, Austin, TX (US); Michael E. Simmons, Colton, OR (US); Joseph George Frankel, Beaverton, OR (US); Divya Pratap, Beaverton, OR (US)

(21) Appl. No.: 19/053,302

(22) Filed: Feb. 13, 2025

Related U.S. Application Data
(60) Provisional application No. 63/643,801, filed on May 7, 2024.

(51) Int. Cl. G01M 11/00; G01M 11/02; G02B 6/42

(52) U.S. Cl. CPC G01M 11/33; G01M 11/0214; G02B 6/4204

(57) ABSTRACT

Lens arrays, fiber optic fixtures that include the lens arrays, probe systems that include the fiber optic fixtures, and methods of forming fiber optic fixtures are disclosed herein. The lens arrays are configured to convey a plurality of electromagnetic signals between a plurality of fiber optic conduits of a fiber optic fixture and a plurality of optical devices of a device under test (DUT). The lens arrays include a single lens block that defines a fixture-attached block side and a lensed block side. The fixture-attached block side is configured to face toward, and be operatively attached to, a fixture body of the fiber optic fixture. The lensed block side differs from the fixture-attached block side. The lens arrays also include a plurality of lenses defined on the lensed block side.

### RELATED APPLICATION

This application claims priority to U.S. Provisional Patent Application Ser. No. 63/643,801, which was filed on May 7, 2024, and the complete disclosure of which is hereby incorporated by reference.

### FIELD OF THE DISCLOSURE

The present disclosure relates generally to lens arrays, to fiber optic fixtures that include the lens arrays, to probe systems that include the fiber optic fixtures, and to methods of forming fiber optic fixtures.

### BACKGROUND OF THE DISCLOSURE

Conventional fiber optic fixtures, such as are illustrated in FIGS. 1-2 and indicated at 400, may utilize a plurality of conventional elongate lenses 410 to convey a plurality of corresponding electromagnetic signals to and/or from a device under test (DUT). The thin and/or long shape of conventional elongate lenses 410 may be fragile, may be prone to damage during installation and/or operative use, and/or may vibrate during high frequency alignment operations. In addition, a mounting area between each conventional elongate lens and a remainder of the conventional fiber optic fixture may be relatively small. As such, the conventional elongate lenses inadvertently may detach from the remainder of the conventional fiber optic fixture. Thus, there exists a need for improved lens arrays, for improved fiber optic fixtures that include the lens arrays, for improved probe systems that include the fiber optic fixtures, and for improved methods of forming fiber optic fixtures.

### SUMMARY OF THE DISCLOSURE

Lens arrays, fiber optic fixtures that include the lens arrays, probe systems that include the fiber optic fixtures, and methods of forming fiber optic fixtures are disclosed herein. The lens arrays are configured to convey a plurality of electromagnetic signals between a plurality of fiber optic conduits of a fiber optic fixture and a plurality of optical devices of a device under test (DUT). The lens arrays include a single lens block that defines a fixture-attached block side and a lensed block side. The fixture-attached block side is configured to face toward, and be operatively attached to, a fixture body of the fiber optic fixture. The lensed block side differs from the fixture-attached block side. The lens arrays also include a plurality of lenses defined on the lensed block side.

The fiber optic fixtures include a fixture body that defines a lens-receiving surface. The fiber optic fixtures also include a plurality of fiber optic conduits terminating at the lens-receiving surface. The fiber optic fixtures further include a lens array according to the present disclosure, and the fixture-attached block side of the lens block is operatively attached to the lens-receiving surface of the fixture body.

The probe systems include a DUT support fixture configured to operatively support the DUT. The probe systems also include the fiber optic fixture that includes the lens array. The probe systems further include an electromagnetic signal generation and analysis assembly configured to at least one of provide at least a provided subset of the plurality of electromagnetic signals to a corresponding providing subset of the plurality of fiber optic conduits and receive at least a received subset of the plurality of electromagnetic signals from a corresponding receiving subset of the plurality of fiber optic conduits.

The methods include 3D printing at least a region of the lens array.

### BRIEF DESCRIPTION OF THE DRAWINGS

FIG. 1 is a schematic illustration of an example of a conventional fiber optic fixture.

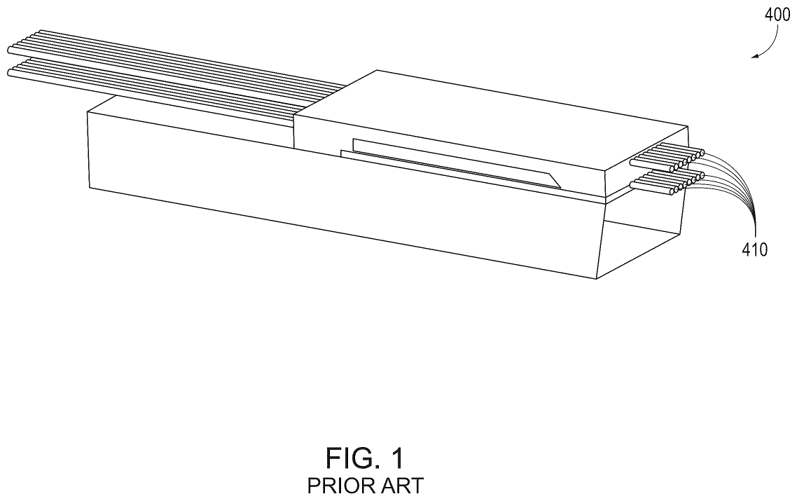

FIG. 2 is a more detailed view of a region of the conventional fiber optic fixture of FIG. 1.

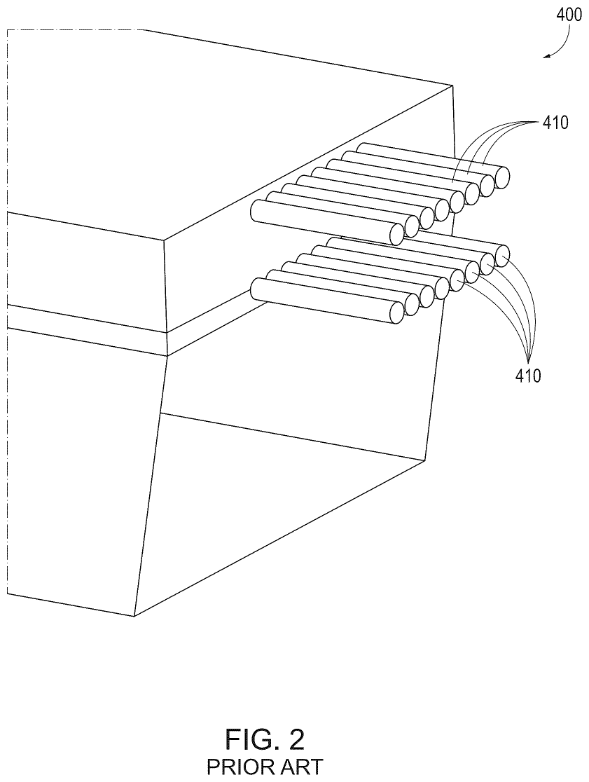

FIG. 3 is a schematic illustration of examples of a probe system that includes a fiber optic fixture that includes a lens array, according to the present disclosure.

FIG. 4 is a schematic illustration of an example of a fiber optic fixture according to the present disclosure.

FIG. 5 is a more detailed view of a region of the fiber optic fixture of FIG. 4.

FIG. 6 is a schematic illustration of another example of a fiber optic fixture according to the present disclosure.

FIG. 7 is a more detailed view of a region of the fiber optic fixture of FIG. 6.

FIG. 8 is a schematic side view illustrating examples of another fiber optic fixture according to the present disclosure.

FIG. 9 is a schematic front view of the fiber optic fixture of FIG. 8.

FIG. 10 is a flowchart depicting examples of methods of forming a fiber optic fixture, according to the present disclosure.

### DETAILED DESCRIPTION AND BEST MODE OF THE DISCLOSURE

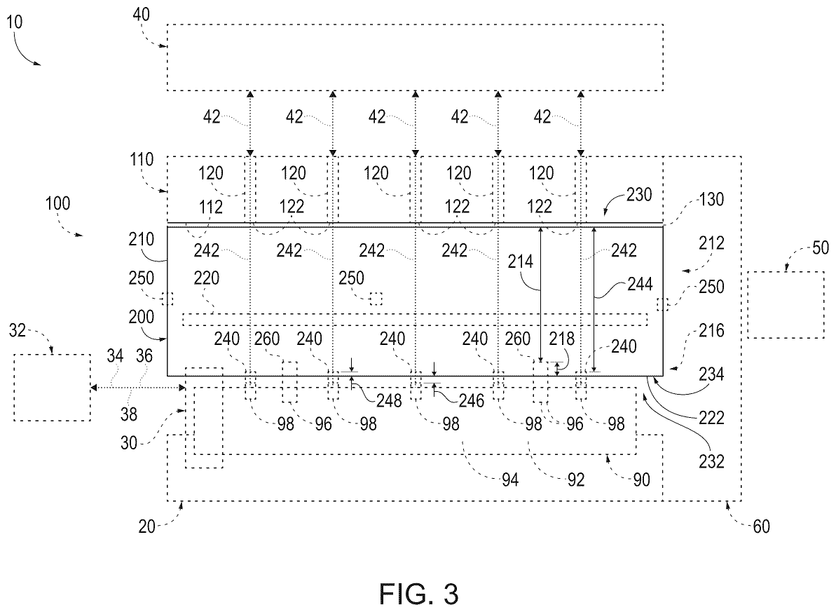

FIGS. 3-10 provide examples of lens arrays 200, of fiber optic fixtures 100 that include lens arrays 200, of probe systems 10 that include fiber optic fixtures 100, and/or of methods 300, according to the present disclosure. Elements that serve a similar, or at least substantially similar, purpose are labeled with like numbers in each of FIGS. 3-10, and these elements may not be discussed in detail herein with reference to each of FIGS. 3-10. Similarly, all elements may not be labeled in each of FIGS. 3-10, but reference numerals associated therewith may be utilized herein for consistency. Elements, components, and/or features that are discussed herein with reference to one or more of FIGS. 3-10 may be included in and/or utilized with any of FIGS. 3-10 without departing from the scope of the present disclosure.

In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

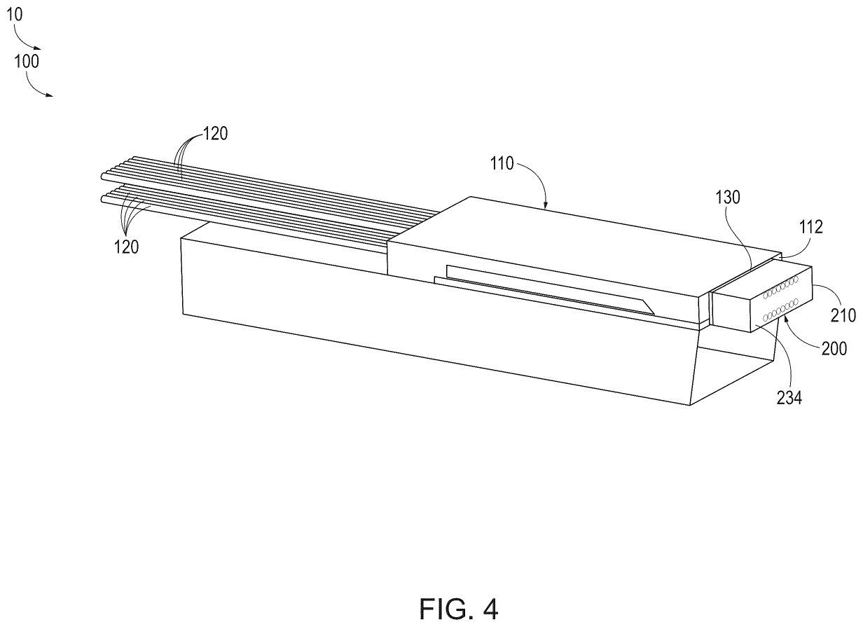

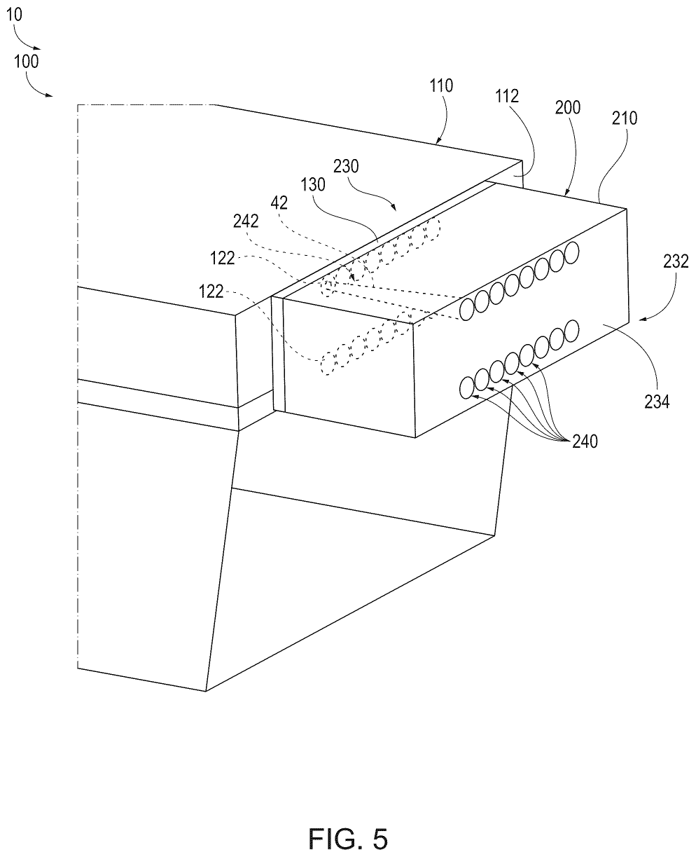

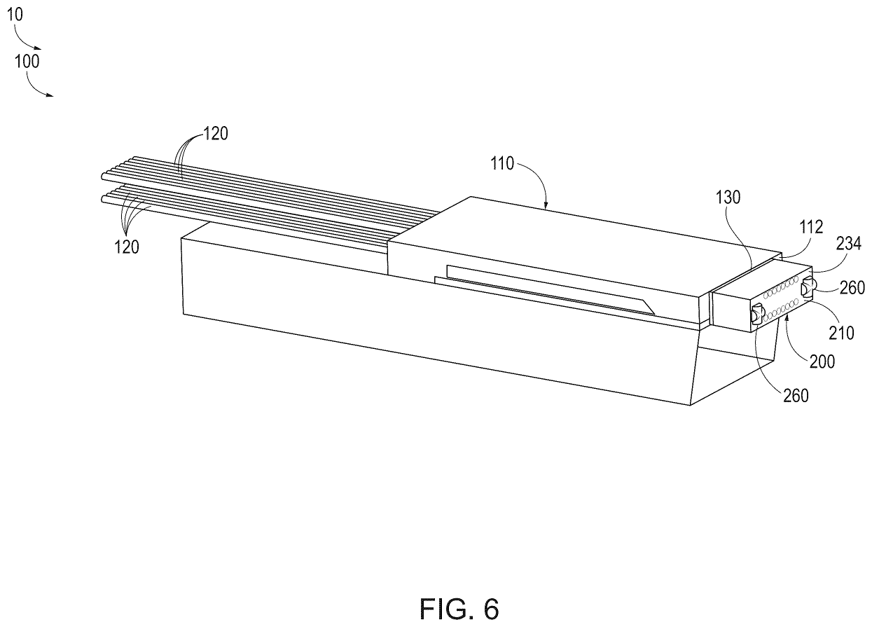

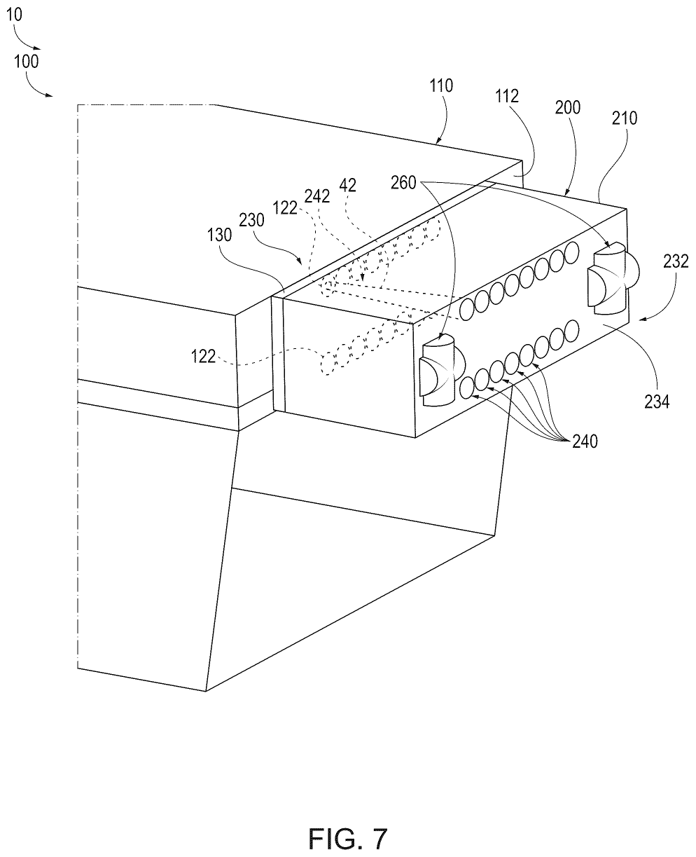

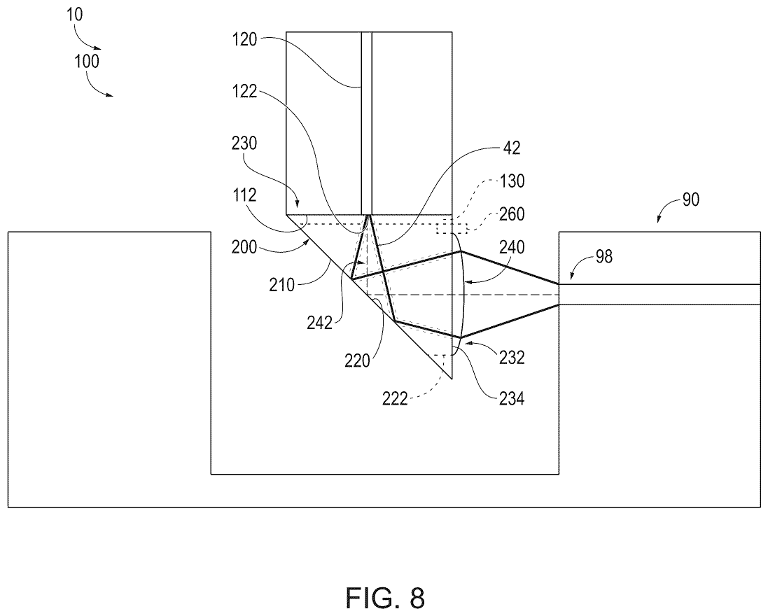

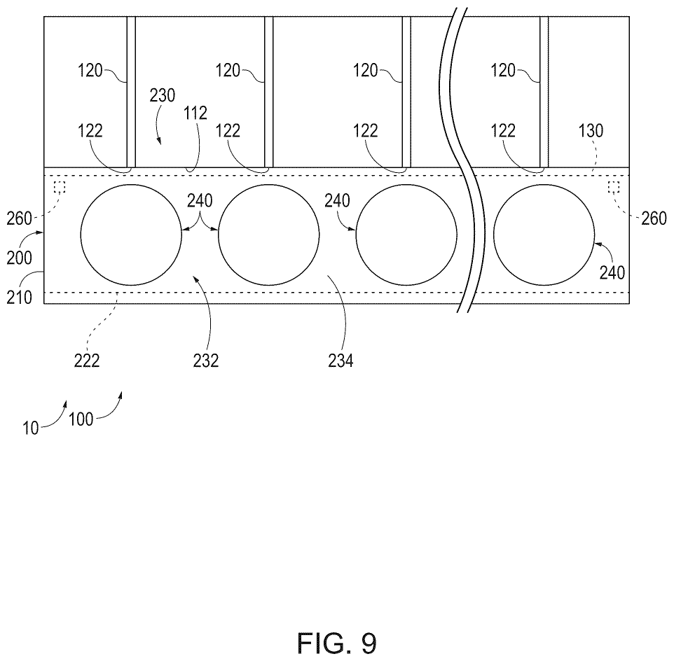

FIG. 3 is a schematic illustration of examples of probe systems 10 that include fiber optic fixtures 100 that include a lens array 200, according to the present disclosure. FIG. 4 is a schematic illustration of an example of a fiber optic fixture 100 according to the present disclosure, and FIG. 5 is a more detailed view of a region of the fiber optic fixture of FIG. 4. FIG. 6 is a schematic illustration of another example of a fiber optic fixture 100 according to the present disclosure, and FIG. 7 is a more detailed view of a region of the fiber optic fixture of FIG. 6. FIG. 8 is a schematic side view illustrating examples of another fiber optic fixture according to the present disclosure, and FIG. 9 is a schematic front view of the fiber optic fixture of FIG. 8.

As illustrated in FIG. 3, probe systems 10 include a DUT support fixture 20, which is configured to support, or to operatively support, a device under test (DUT) 90. Probe systems 10 also include fiber optic fixture 100 that includes lens array 200. Probe systems 10 further include an electromagnetic signal generation and analysis assembly 40, which may be configured to provide one or more electromagnetic signals 42 to DUT 90 and/or to receive one or more electromagnetic signals 42 from DUT 90. As discussed in more detail herein, lens array 200 may be configured to convey a plurality of electromagnetic signals 42 between a plurality of fiber optic conduits 120 of fiber optic fixture 100 and a plurality of optical devices 98 of DUT 90. As an example, lens array 200 may be configured to convey the plurality of electromagnetic signals 42 between terminal ends 122 of fiber optic conduits 120 of fiber optic fixture 100 and the plurality of optical devices 98 of DUT 90.

With this in mind, electromagnetic signal generation and analysis assembly 40 may be configured to provide at least a provided subset of the plurality of electromagnetic signals 42 to a corresponding providing subset of the plurality of fiber optic conduits 120. Additionally or alternatively, electromagnetic signal generation and analysis assembly 40 may be configured to receive at least a received subset of the plurality of electromagnetic signals 42 from a corresponding receiving subset of the plurality of fiber optic conduits 120. Examples of electromagnetic signal generation and analysis assembly 40 include a light source, a laser light source, a source of electromagnetic radiation, a light emitting diode, a light detector, a laser light detector, an electromagnetic radiation detector, a photosensor, and/or a photodetector.

DUT support fixture 20 may include any suitable structure that may be adapted, configured, sized, and/or shaped to support, or to operatively support, DUT 90, such as with respect to and/or relative to fiber optic fixture 100. In general, DUT 90 is a singulated DUT 92, which has been singulated and/or separated from a corresponding substrate, and/or a packaged DUT 94, which has been packaged for assembly and/or test. Stated differently, probe systems 10 generally are configured to test individual DUTs 90 subsequent to the individual DUTs being singulated from the substrate that includes a plurality of DUTs 90 and/or subsequent to the DUT being packaged. However, this is not required to all examples, and it is within the scope of the present disclosure that probe systems 10 may be configured to test one or more DUTs 90 prior to singulation of the DUTs from the corresponding substrate. Examples of DUT support fixture 20 include a surface that supports DUT 90, a surface that supports the corresponding substrate, or a wafer, that includes DUT 90, a wafer chuck, and/or a socket configured to receive DUT 90.

As illustrated in dashed lines in FIG. 3, probe systems 10 may include an, or at least one, electrical probe 30. Electrical probe 30 may be adapted, configured, designed, and/or constructed to provide an electric test signal 34 to DUT 90, to provide an electric power signal 36 to DUT 90, and/or to receive an electric resultant signal 38 from DUT 90. Examples of electrical probe 30 include a spring-loaded electrical probe, a pogo pin, a membrane-attached probe, a needle probe, an electrically conductive point contact, and/or an electrically conductive surface.

Electrical probe 30 may be incorporated into probe system 10 in any suitable manner. In some examples, electrical probe 30 may form a portion of and/or may be integrated with DUT support fixture 20. In some examples, electrical probe 30 may form a portion of and/or may be integrated with fiber optic fixture 100. In some examples, electrical probe 30 may be separate and/or distinct from DUT support fixture 20 and/or from fiber optic fixture 100.

When probe systems 10 include electrical probe 30, the probe systems also may include an electric signal generation and analysis assembly 32. Electric signal generation and analysis assembly 32 may be configured to provide the electric test signal to electrical probe 30, to provide the electric power signal to electrical probe 30, and/or to receive the electric resultant signal from electrical probe 30. Examples of electric signal generation and analysis assembly 32 include an electric current source, an electric voltage source, an alternating current source, a direct current source, a function generator, a voltage meter, a current meter, an electric signal analyzer, and/or an impedance analyzer.

In some examples, and as illustrated in dashed lines in FIG. 3, probe systems 10 may include an optical assembly 50. Optical assembly 50 may be adapted, configured, designed, and/or constructed to collect an optical image of one or more other components of probe system 10. As examples, optical assembly 50 may be configured to collect the optical image of, or of at least a portion and/or region of, DUT support fixture 20, electrical probe 30, DUT 90, fiber optic fixture 100, lens array 200, and/or a lens block fiducial 250 of lens array 200. Stated differently, and in some examples, DUT support fixture 20, electrical probe 30, DUT 90, fiber optic fixture 100, lens array 200, and/or lens block fiducial 250 may be positioned along an optical pathway of optical assembly 50 and/or may be in focus to the optical assembly, such as to permit and/or facilitate collection of the optical image by the optical assembly.

DUT 90 may include and/or be any suitable structure that may be supported by DUT support fixture 20, that may be tested by probe system 10, and/or that may include the plurality of optical devices 98. Examples of DUT 90 include optical devices 98 and/or an optoelectronic device.

In some examples, DUT 90 may include at least one DUT alignment structure 96 and/or lens array 200 may include at least one block alignment structure 260. As discussed in more detail herein, block alignment structure 260 may be configured to operatively engage with DUT alignment structure 96, such as to accurately and/or reproducibly permit, facilitate, and/or establish optical alignment between fiber optic fixture 100 and DUT 90.

As illustrated in dashed lines in FIG. 3, probe system 10 may include a translation structure 60. Translation structure 60 may be configured to translate and/or rotate fiber optic fixture 100 and DUT support fixture 20 relative to one another, such as via motion of the DUT support fixture, motion of the fiber optic fixture, and/or relative motion between the DUT support fixture and the fiber optic fixture. Such a configuration may permit and/or facilitate relative motion and/or alignment between the fiber optic fixture and DUT 90. Examples of translation structure 60 include an actuator, a linear actuator, a rotary actuator, a rack and pinion assembly, a ball screw and nut assembly, a motor, a stepper motor, a servo motor, and/or a piezoelectric actuator.

As collectively illustrated by FIGS. 3-9, and with specific reference to FIG. 3, fiber optic fixtures 100 include a fixture body 110 that defines a lens-receiving surface 112. Fiber optic fixtures 100 also include the plurality of fiber optic conduits 120 terminating at lens-receiving surface 112, as perhaps best illustrated in FIGS. 3-4, 6, and 8-9. Fiber optic fixtures 100 further include lens array 200, which is discussed in more detail herein. Lens array 200 is operatively attached to lens-receiving surface 112 of fixture body 110.

In some examples, fiber optic fixture 100 may include a bonding layer 130 between lens-receiving surface 112 and lens array 200. Bonding layer 130 may be adapted, configured, and/or selected to increase a bond strength between a lens block 210 of lens array 200 and fixture body 110. As an example, bonding layer 130 may be configured to provide a desired bond strength between the lens block and the fixture body, such as to decrease a potential for detachment of the lens block from the fixture body during operative use of the fiber optic fixture.

Bonding layer 130 may define any suitable adhesive strength with lens block 210, with fixture body 110, and/or between the lens block and the fixture body. Examples of the adhesive strength include adhesive strengths of at least 0.4 megapascals (mPa), at least 0.45 mPa, at least 0.5 mPa, at least 0.55 mPa, at least 0.6 mPa, at least 0.7 mPa, at least 0.8 mPa, at least 0.9 mPa, or at least 1 mPa.

Bonding layer 130 may have a bond layer refractive index. In some examples, the bond layer refractive index may be selected to match, or at least substantially match, a lens block material refractive index of lens block 210. Such a configuration may permit the plurality of electromagnetic signals to behave consistently and/or similarly when they pass through both the bonding layer and the lens block and/or may decrease a potential for reflection and/or refraction of the plurality of electromagnetic signals at an interface between the bonding layer and the lens block. Examples of the bonding layer refractive index include at least 1, at least 1.1, at least 1.2, at least 1.3, at least 1.4, at least 1.48, at least 1.49, at least 1.5, at least 1.51, at least 1.52, at least 1.53, at least 1.54, at least 1.6, at least 1.8, at least 2, at most 3, at most 2.8, at most 2.6, at most 2.4, at most 2.2, at most 2, at most 1.8, at most 1.6, at most 1.59, at most 1.58, at most 1.57, at most 1.56, at most 1.55, and/or at most 1.54.

Bonding layer 130 may be configured to permit and/or facilitate transfer of electromagnetic signals 42 between fiber optic conduits 120 and lens array 200. As an example, bonding layer 130 may be transparent, at least substantially transparent, optically transparent, and/or at least substantially optically transparent to the plurality of electromagnetic signals. As another example, bonding layer 130 may be transparent, at least substantially transparent, optically transparent, and/or at least substantially optically transparent at an electromagnetic signal frequency of the plurality of electromagnetic signals.

In some examples, lens array 200 may include and/or be a single, a unitary, and/or a monolithic structure that defines lens block 210 and the plurality of lenses 240. As an example, lens array 200, or an entirety of lens array 200, may be additively manufactured and/or 3D printed. In some such examples, lens array 200 may be formed and/or 3D printed on lens-receiving surface 112 of fixture body 110. Stated differently, lens array 200 may be operatively attached to lens-receiving surface 112 during formation of the lens array and/or responsive to formation of the lens array. In some such examples, bonding layer 130 may be formed and/or 3D printed on lens-receiving surface 112, with lens array 200 being formed and/or 3D printed on bonding layer 130 of fiber optic fixture 100. In some such examples, fixture body 110, fiber optic conduits 120, bonding layer 130, and/or lens array 200 may be formed utilizing a, or a single, 3D printing process.

Additionally or alternatively, and in some examples, lens array 200 may be a composite and/or a multi-component structure. As an example, lens block 210 and the plurality of lenses 240 may be separately formed and/or defined, may be formed and/or defined at different times, may be formed and/or defined utilizing different manufacturing processes, and/or may be formed and/or defined utilizing different materials. As a more specific example, lens block 210 initially may be formed and/or defined, and the plurality of lenses 240 subsequently may be formed on the lens block and/or added to the lens block. In some such examples, lens block 210 may be formed and/or defined from a lens block material, such as a glass. Additionally or alternatively, the plurality of lenses 240 may be formed and/or defined from a lens material, such as a polymer, which may differ from the lens block material. In some such examples, the plurality of lenses 240 may include and/or be additively manufactured lenses and/or 3D printed lenses that are formed and/or defined on lensed block side 232 of the lens block. In some such examples, a rigidity of the lens block material may be greater than a rigidity of the lens material, thereby increasing an overall dimensional stability of lens array 200 when compared to single, unitary, and/or monolithic lens arrays 200 that are 3D printed and/or that are formed entirely from the polymer.

As discussed, lens array 200 may be configured to convey the plurality of electromagnetic signals 42 between fiber optic conduits 120 of fiber optic fixture 100 and a plurality of optical devices 98 of DUT 90. As collectively illustrated by FIGS. 3-9, and with specific reference to FIG. 3, lens block 210 of lens array 200 includes and/or is a single, a monolithic, and/or a unitary lens block 210 that may be formed from and/or defined by the lens block material. Lens block 210 defines a fixture-attached block side 230 and a lensed block side 232. Fixture-attached block side 230 is configured to face toward fixture body 110, to be operatively attached to the fixture body, and/or to face toward a remainder of the fiber optic fixture. Lensed block side 232 differs from fixture-attached block side 230 and may be configured to face away from fixture body 110, to face away from a remainder of the fiber optic fixture, and/or to face toward DUT 90, as perhaps best illustrated in FIGS. 3 and 9.

Lenses 240, external surfaces of lenses 240, and/or curvature of lenses 240 are defined on, or solely on, lensed block side 232 of lens block 210. Stated differently, electromagnetic signals 42 may travel between fixture-attached block side 230 and lensed block side 232 of lens block 210; however, the electromagnetic signals may be focused and/or dispersed, via lenses 240, at, on, only at, and/or only on lensed block side 232. As discussed, lenses 240 may be formed by lens block 210 and thus may form a portion of lensed block side 232. Additionally or alternatively, and as also discussed, lenses 240 may be operatively attached to lensed block side 232.

With continued reference to FIG. 3, lens block 210 may include a homogeneous block region 212. Within the homogeneous block region, any transverse cross-section of the lens block, which is taken within a plane that is parallel to fixture-attached block side 230, may be free from internal structure and, in some examples may have a constant, or at least substantially constant, cross-sectional shape and/or may have a constant, or at least substantially constant, cross-sectional area. The homogeneous block region may extend from fixture-attached block side 230 and toward, or to, lensed block side 232.

When lenses 240 are defined by lens block 210, the lens block also may include a heterogeneous block region 216. In contrast to homogeneous block region 212, within the heterogeneous block region, any transverse cross-section of the lens block, which is taken within the plane that is parallel to the lensed block side, may include internal structure that at least partially defines the plurality of lenses and/or may include a plurality of internal structures that at least partially define the plurality of lenses. Stated differently, heterogeneous block region 216 may include a plurality of surfaces that defines the plurality of lenses.

Homogeneous block region 212 may define a homogeneous region thickness 214. Similarly, heterogeneous block region 216 may define a heterogeneous region thickness 218. Homogeneous region thickness 214 may be measured in a direction that is perpendicular, or at least substantially perpendicular, to the fixture-attached block side, heterogeneous region thickness 218 may be measured in a direction that is perpendicular, or at least substantially perpendicular, to lensed block side 232, and the homogeneous region thickness may be a threshold multiple of the heterogeneous region thickness. Examples of the threshold multiple include at least 10, at least 20, at least 30, at least 40, at least 50, at least 60, at least 70, at least 80, at least 90, at least 100, at least 125, at least 150, at least 175, at least 200, at least 250, at most 500, at most 400, at most 300, at most 200, at most 100, and/or at most 50.

A given lens 240 may be associated with and/or may at least partially define a corresponding signal path 242 along which a corresponding electromagnetic signal 42 may travel between fixture-attached block side 230 and the given lens. Given lens 240 also may be referred to herein as a selected lens 240 and/or as one lens 240 of the plurality of lenses 240. Corresponding signal path 242 for each lens 240 may be defined and/or may extend within, only within, and/or solely within lens block 210 and/or the lens block material of lens block 210, at least between the fixture-attached block side and the given lens. Each signal path 242 may define a corresponding signal path length 244. In some examples, the corresponding signal path length may be constant, or at least substantially constant, for each lens 240. Such a configuration may permit each electromagnetic signal 42 to experience similar, the same, and/or identical refraction, focus, and/or dispersion within the corresponding lens. In other examples, the corresponding signal path length of at least one lens 240 may differ from the corresponding signal path length of at least one other lens. Such a configuration may permit lens array 200 to provide selectively different refraction, focus, and/or dispersion for different electromagnetic signals 42 that are conveyed therethrough.

Each lens 240 may have and/or define a corresponding lens shape. The corresponding lens shape may be constant, or at least substantially constant, for each lens. Such a configuration may permit each electromagnetic signal 42 to experience similar, the same, and/or identical refraction, focus, and/or dispersion within the corresponding lens. Alternatively, the corresponding lens shape of at least one lens may differ from the corresponding lens shape of at least one other lens. Such a configuration may permit lens array 200 to provide selectively different refraction, focus, and/or dispersion for different electromagnetic signals 42.

Each lens 240 may define a corresponding lens curvature. The corresponding lens curvature may be selected and/or determined based upon any suitable criteria. As examples, the corresponding lens curvature may be selected based, at least in part, on an identity of the DUT, an identity of a corresponding optical device with which each lens is configured to convey a corresponding electromagnetic signal of the plurality of electromagnetic signals, a desired focal length for each lens, and/or signal path length for each lens.

Lensed block side 232 may have and/or define a lensed block side face 234. The lensed block side face may include and/or be a planar, or at least substantially planar, lensed block side face. One or more lenses 240 may project from the lensed block side face, such as by a corresponding lens projection distance. This is illustrated in FIGS. 4-8 and also is illustrated in FIG. 3 by the dashed lines of lenses 240 that project from lensed block side face 234, with the lens projection distance being indicated at 246. Such a configuration may permit lenses 240 to approach closely to DUT 90 and/or to optical devices 98 of DUT 90, such as may be beneficial when lenses 240 have a relatively shorter focal length. Additionally or alternatively, one or more lenses 240 may be recessed from lensed block side face 234 and into lens block 210 by a corresponding lens recess distance. This is schematically illustrated in FIG. 3 by the dashed lines of lenses 240 that extend into lens block 210, with the lens recess distance being indicated at 248. Such a configuration may permit lens block 210 and/or lensed block side face 234 to protect lenses 240 from scratching and/or damage. Additionally or alternatively, such a configuration may be beneficial and/or facilitated when lenses 240 have a relatively longer focal length.

Lenses 240 may be arranged with any suitable relative orientation on lens array 200. In general, the relative orientation of lenses 240, when viewed from lensed block side 232 of lens block 210 may correspond to a relative orientation of optical devices 98 on DUT 90. Stated differently, lens array 200 may be adapted and/or configured to facilitate alignment between lenses 240, or between all lenses 240, of the lens array, and optical devices 98, all optical devices 98, or a probed subset of optical devices 98, of DUT 90. As examples, lenses 240 may be arranged in at least one row and/or in a plurality of rows on lensed block side 232 of lens block 210.

Lens array 200 may include any suitable number of lenses 240. As examples, lens array 200 may include at least 2, at least 4, at least 6, at least 8, at least 10, at least 12, at least 14, at least 16, at least 18, at least 20 lenses, at most 100, at most 90, at most 80, at most 70, at most 60, at most 50, at most 40, at most 30, at most 20, and/or at most 10 lenses 240.

Lens block 210 may be formed and/or defined from and/or utilizing any suitable lens block material. In some examples, the lens block material may include and/or be a 3D printed lens block material and/or a lens block material that is configured to be 3D printed. Additional examples of the lens block material include a polymeric lens block material and/or a glass lens block material. In some examples, one or more optical characteristics of the lens block material may be selected to correspond to one or more characteristics of fiber optic conduits 120. As an example, the lens block material may be transparent, or at least substantially transparent, to electromagnetic signals 42 and/or at the electromagnetic signal frequency of electromagnetic signals 42. As another example, a block material refractive index of the lens block material may correspond to a fiber optic conduit refractive index of the fiber optic conduits. Examples of the block material refractive index include at least at least 1, at least 1.1, at least 1.2, at least 1.3, at least 1.4, 1.48, at least 1.49, at least 1.5, at least 1.51, at least 1.52, at least 1.53, at least 1.54, at least 1.6, at least 1.8, at least 2, at most 3, at most 2.8, at most 2.6, at most 2.4, at most 2.2, at most 2, at most 1.8, at most 1.6, at most 1.59, at most 1.58, at most 1.57, at most 1.56, at most 1.55, and/or at most 1.54.

As illustrated in dashed lines in FIG. 3, and as discussed, lens array 200 and/or lens block 210 thereof may have and/or define one or more lens block fiducials 250. Lens block fiducials 250 may be configured to be visible to optical assembly 50 of probe system 10, such as to permit and/or facilitate improved alignment between lens array 200 and DUT 90. In some examples, lens block 210 may include a plurality of lens block fiducials 250. The plurality of lens block fiducials may include a first lens block fiducial, which is configured to be visible to the optical assembly from a first direction, a second lens block fiducial, which is configured to be visible to the optical assembly from a second direction that is perpendicular, or at least substantially perpendicular, to the first direction, and/or a third lens block fiducial, which is configured to be visible to the optical assembly from a third direction that is perpendicular, or at least substantially perpendicular, to the first direction and the second direction.

Lens block fiducial 250 may include and/or be any suitable structure that is configured to be visible to optical assembly 50. As examples, lens block fiducials 250 may include and/or be a fiducial mark formed on the lens block, a fiducial target operatively attached to the lens block, and/or a fiducial structure at least partially formed by and/or within the lens block.

As illustrated in dashed lines in FIGS. 3 and 8-9 and in solid lines in FIGS. 6-7, and as discussed, lens array 200 and/or lens block 210 thereof may include and/or define one or more block alignment structures 260. As illustrated in FIG. 3, and as discussed, block alignment structures 260 may be adapted, configured, shaped, and/or sized to operatively engage with corresponding DUT alignment structures 96 of DUT 90, such as to permit and/or facilitate optical alignment, improved optical alignment, and/or more efficient optical alignment between lenses 240 of lens array 200 and optical devices 98 of DUT 90.

A block alignment structure shape of block alignment structure 260 may be based, at least in part, on a DUT alignment structure shape of the DUT alignment structure. As examples, the block alignment structure shape may correspond to the DUT alignment structure shape of the DUT alignment structure, the block alignment structure may be shaped to be received within the DUT alignment structure, and/or the block alignment structure may be shaped to receive the DUT alignment structure. Examples of the block alignment structure shape include a plus-shaped, or at least partially plus-shaped, block alignment structure; a rectangular, or at least partially rectangular, block alignment structure; a wedge-shaped, or at least partially wedge-shaped, block alignment structure; a conical, or at least partially conical, block alignment structure; a spherical, or at least partially spherical, block alignment structure; and/or a tapered, or at least partially tapered, block alignment structure.

When block alignment structure 260 is operatively engaged with DUT alignment structure 96, the block alignment structure and the DUT alignment structure may position, precisely position, and/or accurately position lens array 200 and DUT 90 relative to one another. This may include positioning the lens array and the DUT relative to one another in at least one direction, in two perpendicular directions, and/or in three orthogonal directions. In addition, lens array 200 may be configured for improved, desired, and/or optimal optical coupling between lenses 240 and optical devices 98 of DUT 90 when the block alignment structure is operatively engaged with the DUT alignment structure. Such a configuration may improve overall efficiency of probe system 10 when compared to conventional probe systems that do not include the block alignment structure and/or that utilize a scanning methodology to optimize coupling between a corresponding lens and a corresponding optical device, as lens array 200 and the DUT 90 may be brought into optical alignment simply by engaging block alignment structure 260 with DUT alignment structure 96.

Block alignment structure 260 may be formed and/or defined on lensed block side 232. In some examples, block alignment structure 260 may project from lensed block side face 234 of the lensed block side. In some examples, block alignment structure 260 may be recessed from the lensed block side face of the lensed block side and/or may be recessed within lens block 210.

Lens array 200 and/or lens block 210 thereof may have and/or define any suitable number of block alignment structures 260. As examples, lens array 200 may include exactly one block alignment structure, a plurality of spaced-apart block alignment structures, exactly two block alignment structures, or exactly three block alignment structures. When lens block 210 includes three, or exactly three, block alignment structures, the block alignment structures may be configured to define a kinematic, or quasi-kinematic, constraint between the lens array and the DUT.

It is within the scope of the present disclosure that probe systems 10, fiber optic fixtures 100, and/or lens arrays 200 may be configured to optically couple with DUT 90 and/or with optical devices 98 thereof in any suitable manner. As an example, and as perhaps best illustrated by FIG. 3 and by the examples of fiber optic fixture 100 that are illustrated in FIGS. 4-7, fiber optic fixtures 100 and/or lens arrays 200 may be configured for surface coupling with DUTs 90 and/or with optical devices 98 thereof. In such a configuration, fixture-attached block side 230 and lensed block side 232 may be on opposed, or opposite, sides of lens block 210, may face away from one another, and/or may be parallel, or at least substantially parallel, to one another. Additionally or alternatively, and in such a configuration, signal path 242 through lens block 210 may be linear, may be at least substantially linear, and/or may not include reflection within the lens block. Additionally or alternatively, and in such a configuration, lens block 210 may include and/or be a rectilinear, or at least substantially rectilinear, lens block 210.

As another example, and as perhaps best illustrated by FIG. 3 and by the examples of fiber optic fixture 100 that are illustrated in FIGS. 8-9, fiber optic fixtures 100 and/or lens arrays 200 may be configured for edge coupling with DUTs 90 and/or with optical devices 98 thereof. In such a configuration, lens block 210 may include a reflection surface 220 configured to reflect electromagnetic signals 42 to convey the electromagnetic signals between fiber optic conduits 120 and lenses 240, and such a lens block 210 may be referred to herein as a prismatic lens block. Additionally or alternatively, and in such a configuration, signal path 242 through lens block 210 may be nonlinear and/or may include at least one reflection within the lens block. Stated differently, fixture-attached block side 230 and lensed block side 232 may be angled relative to one another, such as at a skew angle and/or at a right angle, and/or may not be parallel to one another.

With continued reference to FIGS. 3 and 8-9, and as illustrated in dashed lines, lens block 210 may include a blunt, rounded, and/or flat surface 222. Such a configuration may decrease a potential for damage to lens block 210 and/or to DUT 90 should lens array 200 inadvertently contact the DUT.

During operative use of probe systems 10 to test DUTs 90, and with primary reference to FIG. 3, lens array 200 of fiber optic fixture 100 may be operatively aligned with and/or focused on optical devices 98 of DUT 90. In some examples, such as when lens array 200 does not include block alignment structure 260, this operative alignment may include moving the lens array and the DUT relative to one another, such as utilizing translation structure 60, to establish desired and/or optimum optical coupling between lenses 240 and optical devices 98 of DUT 90. In some examples, such as when lens array 200 includes block alignment structure 260, this operative alignment may include operatively engaging the block alignment structure with DUT alignment structure 96.

Subsequently, electromagnetic signals 42 may be conveyed between fiber optic conduits 120 and DUT 90 via lens array 200. At least a subset of the electromagnetic signals may be detected, quantified, and/or analyzed, such as via electromagnetic signal generation and analysis assembly 40, thereby permitting optical testing of DUT 90 and/or quantification of one or more operational characteristics of DUT 90.

Probe systems 10 that include fiber optic fixtures 100 that include lens arrays 200, according to the present disclosure, may provide benefits over conventional probe systems that include conventional fiber optic fixtures and/or conventional elongate lenses. As an example, probe systems 10 and/or lens arrays 200 may exhibit increased robustness when compared to the conventional probe systems. As more specific examples, lens arrays 200 may be less prone to damage, may be more durable, and/or may be more reliable when compared to conventional elongated lenses. This increased durability may be such that physical contact between lens array 200 and DUT 90, such as via block alignment structure 260 and DUT alignment structure 96, is permissible and/or may be repeatedly established and subsequently ceased without damage to lens array 200, without debonding of the lens array from fixture body 110, and/or without damage to DUT 90.

The increased robustness and/or durability of probe systems 10 and/or of lens arrays 200 additionally or alternatively may decrease operational costs associated with utilizing probe systems 10. In particular, a replacement frequency for lens block 210 may be lower when compared to conventional elongate lenses at least because lens blocks 210 may be less prone to separation from fixture body 110 when compared to conventional elongate lenses. Additionally or alternatively, and when lenses 240 are recessed from the lensed block side face and/or into the lens block, the lenses may be protected from debris and/or damage by the lensed block side face.

As another example, the presence of block alignment structures 260 may permit and/or facilitate improved, more effective, more reproduceable, and/or more efficient optical coupling between lens array 200 and DUT 90 when compared to the conventional probe systems. This improved optical coupling may be achieved without requiring highly accurate and/or complex positioning systems, such as may be utilized in the conventional probe systems, thereby decreasing overall system costs.

As yet another example, lens blocks 210 may be less costly to install when compared to conventional elongate lenses. As another example, installation of a single lens block 210 may be simpler, more efficient, and/or less time-consuming when compared to installation of a plurality of elongate lenses.

As another example, probe systems 10 that include lens blocks 210 may be more stable and/or precise when compared to conventional probe systems that utilize conventional elongate lenses. As an example, a single lens of lens block 210 cannot readily be misaligned from other lenses of the lens block. In contrast, a single conventional elongate lens may be misaligned from other conventional elongate lenses in an array of conventional elongate lenses. As another example, the presence of block alignment structure 260 may permit more stable and/or precises alignment between lens block 210 and DUT 90 when compared to conventional probe systems that do not include the block alignment structure.

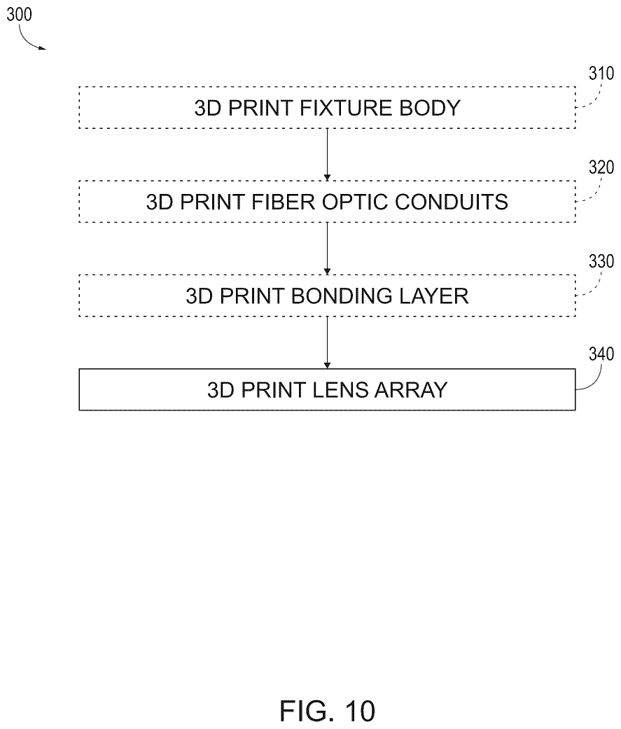

FIG. 10 is a flowchart depicting examples of methods 300 of forming a fiber optic fixture of a probe system, according to the present disclosure. Examples of the fiber optic fixture and/or components thereof are disclosed herein with reference to fiber optic fixture 100. Methods 300 may include 3D printing a fixture body at 310, 3D printing fiber optic conduits at 320, and/or 3D printing a bonding layer at 330. Methods 300 include 3D printing a lens array at 340. 3D printing the fixture body at 310 may include 3D printing any suitable structure that is disclosed herein with reference to fixture body 110. 3D printing fiber optic conduits at 320 may include 3D printing any suitable structure that is disclosed herein with reference to fiber optic conduits 120. In some examples, the 3D printing at 310 and the 3D printing at 320 may be performed concurrently, at least partially concurrently, or at least substantially concurrently. As an example, methods 300 may include performing both the 3D printing at 310 and the 3D printing at 320 to embed, or at least partially embed, the fiber optic conduits within the fixture body and/or such that the fiber optic conduits are at least partially supported by the fixture body. 3D printing a bonding layer at 330 may include 3D printing any suitable structure that is disclosed herein with reference to bonding layer 130. The 3D printing at 330 may be performed with any suitable timing and/or sequence during methods 300. As examples, the 3D printing at 330 may be performed subsequent to the 3D printing at 310, subsequent to the 3D printing at 320, and/or prior to the 3D printing at 340.

3D printing the lens array at 340 may include 3D printing any suitable portion, region, subset, and/or structure of the lens array. Examples of the lens array are disclosed herein with reference to lens array 200.

In some examples, the 3D printing at 340 may include 3D printing the lens array on a lens-receiving surface of a fixture body of the fiber optic fixture. The fixture body may include a plurality of fiber optic conduits, which may terminate at the lens-receiving surface, and the 3D printing at 340 may include printing such that a relative orientation of a plurality of lenses of the lens array corresponds to a relative orientation of a terminal end of the plurality of fiber optic conduits on the lens-receiving surface. Examples of the fixture body are disclosed herein with reference to fixture body 110. Examples of the plurality of fiber optic conduits are disclosed herein with reference to fiber optic conduits 120.

In some such examples, the 3D printing at 340 may include 3D printing the lens array as a single, as a monolithic, and/or as a unitary structure. Stated differently, the lens array may include and/or be a single-piece structure, which may be formed from a, or a single, lens block material that defines lens array 200.

Additionally or alternatively, in some examples, and as discussed, the lens array may include and/or be a composite lens array. As an example, and as also discussed, the lens array may include a lens block, examples of which are disclosed herein with reference to lens block 210, and a plurality of lenses, examples of which are disclosed herein with reference to lenses 240, that may be separately formed and/or defined, may be formed and/or defined at different times, may be formed and/or defined utilizing different manufacturing processes, and/or may be formed and/or defined utilizing different materials. In some such examples, the 3D printing at 340 may include 3D printing the plurality of lenses on a previously formed and/or defined lens block. In some such examples, the lens block may include and/or be a glass lens block. In some such examples, methods 300 also may include operatively attaching the lens block to the fixture body, such as via the bonding layer.

The 3D printing at 340 may be performed with any suitable timing and/or sequence during methods 300. As examples, the 3D printing at 340 may be performed subsequent to the 3D printing at 310, subsequent to the 3D printing at 320, and/or subsequent to the 3D printing at 330. In some examples, the 3D printing at 310, the 3D printing at 320, the 3D printing at 330, and the 3D printing at 340 may be performed, or sequentially performed, as part of a single, or a continuous, 3D printing process.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of lens arrays, fiber optic fixtures, probe systems, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.
A1. A lens array configured to convey a plurality of electromagnetic signals between a plurality of fiber optic conduits of a fiber optic fixture and a plurality of optical devices of a device under test (DUT), the lens array comprising:
a single lens block, a monolithic lens block, or a unitary lens block, optionally that is formed from a lens block material, that defines:
(i) a fixture-attached block side, which is configured to face toward, and be operatively attached to, a fixture body of the fiber optic fixture; and
(ii) a lensed block side, which differs from the fixture-attached block side; and a plurality of lenses defined on the lensed block side.
A2. The lens array of paragraph A1, wherein the plurality of lenses is defined solely on the lensed block side.
A3. The lens array of any of paragraphs A1-A2, wherein the lens block includes a homogeneous block region within which a transverse cross-section of the lens block, which is taken within a plane that is parallel to the fixture-attached block side, is free from internal structure.
A4. The lens array of paragraph A3, wherein the homogeneous block region extends from the fixture-attached block side and toward, or to, the lensed block side.
A5. The lens array of any of paragraphs A3-A4, wherein the lens block includes a heterogenous block region within which a transverse cross-section of the lens block, which is taken within a plane that is parallel to the lensed block side, includes a plurality of internal structures that at least partially define the plurality of lenses.
A6. The lens array of paragraph A5, wherein the heterogeneous block region includes a plurality of surfaces that defines the plurality of lenses.
A7. The lens array of any of paragraphs A5-A6, wherein a homogeneous region thickness of the homogeneous block region is a threshold multiple of a heterogeneous region thickness of the heterogeneous block region, which is measured in a thickness direction.
A8. The lens array of paragraph A7, wherein the threshold multiple is at least one of: (i) at least 10, at least 20, at least 30, at least 40, at least 50, at least 60, at least 70, at least 80, at least 90, at least 100, at least 125, at least 150, at least 175, at least 200, or at least 250; and
(ii) at most 500, at most 400, at most 300, at most 200, at most 100, or at most 50.
A9. The lens array of any of paragraphs A1-A8, wherein a given lens of the plurality of lenses defines a corresponding signal path between the fixture-attached block side and the given lens.
A10. The lens array of paragraph A9, wherein the corresponding signal path extends solely within the lens block material between the fixture-attached block side and the given lens.
A11. The lens array of any of paragraphs A9-A10, wherein the corresponding signal path defines a corresponding signal path length.
A12. The lens array of paragraph A11, wherein the corresponding signal path length of at least one lens of the plurality of lenses differs from the corresponding signal path length of at least one other lens of the plurality of lenses.
A13. The lens array of any of paragraphs A11-A12, wherein the corresponding signal path length is constant, or at least substantially constant, for each lens of the plurality of lenses.
A14. The lens array of any of paragraphs A1-A13, wherein each lens of the plurality of lenses defines a corresponding lens shape.
A15. The lens array of paragraph A14, wherein the corresponding lens shape is constant, or at least substantially constant, for each lens of the plurality of lenses.
A16. The lens array of any of paragraphs A14-A15, wherein the corresponding lens shape of at least one lens of the plurality of lenses differs from the corresponding lens shape of at least one other lens of the plurality of lenses.
A17. The lens array of any of paragraphs A1-A16, wherein each lens of the plurality of lenses defines a corresponding lens curvature, and further wherein the corresponding lens curvature is selected based, at least in part, on at least one of:
(i) an identity of the DUT;
(ii) an identity of a corresponding optical device with which each lens is configured to convey a corresponding electromagnetic signal of the plurality of electromagnetic signals; (iii) a desired focal length for each lens; and
(iv) a/the signal path length for each lens.
A18. The lens array of any of paragraphs A1-A17, wherein the lensed block side defines a lensed block side face, optionally wherein the lensed block side face is planar, or at least substantially planar.
A19. The lens array of paragraph A18, wherein at least one lens of the plurality of lenses, and optionally all lenses of the plurality of lenses, projects from the lensed block side face by a corresponding lens projection distance.
A20. The lens array of any of paragraphs A18-A19, wherein at least one lens of the plurality of lenses, and optionally all lenses of the plurality of lenses, is recessed from the lensed block side face and into the lens block by a corresponding lens recess distance.
A21. The lens array of any of paragraphs A1-A20, wherein a relative orientation of the plurality of lenses, when viewed from the lensed block side, corresponds to a relative orientation of the plurality of optical devices of the DUT.
A22. The lens array of any of paragraphs A1-A21, wherein the plurality of lenses is arranged in at least one row, and optionally a plurality of rows, on the lensed block side.
A23. The lens array of any of paragraphs A1-A22, wherein the plurality of lenses includes at least one of:
(i) at least 2, at least 4, at least 6, at least 8, at least 10, at least 12, at least 14, at least 16, at least 18, or at least 20 lenses; and
(ii) at most 100, at most 90, at most 80, at most 70, at most 60, at most 50, at most 40, at most 30, at most 20, or at most 10 lenses.
A24. The lens array of any of paragraphs A1-A23, wherein the lens block material has a block material refractive index of at least one of:
(i) at least 1, at least 1.1, at least 1.2, at least 1.3, at least 1.4, at least 1.48, at least 1.49, at least 1.5, at least 1.51, at least 1.52, at least 1.53, at least 1.54, at least 1.6, at least 1.8, at least 2; and
(ii) at most 3, at most 2.8, at most 2.6, at most 2.4, at most 2.2, at most 2, at most 1.8, at most 1.6, at most 1.59, at most 1.58, at most 1.57, at most 1.56, at most 1.55, or at most 1.54.
A25. The lens array of any of paragraphs A1-A24, wherein the lens block material is transparent, or at least substantially transparent, at least one of:
(i) to the plurality of electromagnetic signals; and
(ii) at an electromagnetic signal frequency of the plurality of electromagnetic signals.
A26. The lens array of any of paragraphs A1-A25, wherein the lens block includes a lens block fiducial configured to be visible to an optical assembly of a probe system that includes the lens array.
A27. The lens array of paragraph A26, wherein the lens block fiducial includes at least one of:
(i) a first lens block fiducial configured to be visible to the optical assembly from a first direction;
(ii) a second lens block fiducial configured to be visible to the optical assembly from a second direction, which is perpendicular, or at least substantially perpendicular, to the first direction; and
(iii) a third lens block fiducial configured to be visible to the optical assembly from a third direction, which is perpendicular, or at least substantially perpendicular, to the first direction and the second direction.
A28. The lens array of any of paragraphs A1-A27, wherein the lens block fiducial includes at least one of:
(i) a fiducial mark formed on the lens block;
(ii) a fiducial target operatively attached to the lens block; and
(iii) a fiducial structure at least partially formed by the lens block.
A29. The lens array of any of paragraphs A1-A28, wherein the lens block defines a block alignment structure shaped to operatively engage with a corresponding DUT alignment structure of the DUT to facilitate optical alignment between the plurality of lenses of the lens array and the plurality of optical devices of the DUT.
A30. The lens array of paragraph A29, wherein the block alignment structure includes at least one of:
(i) a plus-shaped, or at least partially plus-shaped, block alignment structure;
(ii) a rectangular, or at least partially rectangular, block alignment structure;
(iii) a wedge-shaped, or at least partially wedge-shaped, block alignment structure; (iv) a conical, or at least partially conical, block alignment structure; and
(v) a tapered, or at least partially tapered, block alignment structure.
A31. The lens array of any of paragraphs A29-A30, wherein a block alignment structure shape of the block alignment structure at least one of:
(i) corresponds to a DUT alignment structure shape of the DUT alignment structure; and
(ii) is shaped to be received within the DUT alignment structure; and
(iii) is shaped to receive the DUT alignment structure.
A32. The lens array of any of paragraphs A29-A31, wherein, when the block alignment structure is operatively engaged with the DUT alignment structure, the block alignment structure and the DUT alignment structure precisely position the lens array and the DUT relative to one another at least one of:
(i) in at least one direction;
(ii) in two perpendicular directions; and
(iii) in three orthogonal directions.
A33. The lens array of any of paragraphs A29-A32, wherein the block alignment structure projects from a/the lensed block side face of the lensed block side.
A34. The lens array of any of paragraphs A29-A33, wherein the block alignment structure is recessed from a/the lensed block side face of the lensed block side and into the lens block.
A35. The lens array of any of paragraphs A29-A34, wherein the lens block defines one of:
(i) exactly one block-alignment structure;
(ii) a plurality of spaced-apart block-alignment structures;
(iii) exactly two block-alignment structures; and
(iv) exactly three block-alignment structures.
A36. The lens array of any of paragraphs A1-A35, wherein the lens block material at least partially, or even fully, defines both the single lens block and the plurality of lenses.
A37. The lens array of any of paragraphs A1-A36, wherein at least one of:
(i) a lens material, which differs from the lens block material, defines the plurality of lenses;
(ii) the lens array is a composite lens array; and
(iii) the lens array is a multi-component lens array.
A38. The lens array of any of paragraphs A1-A37, wherein the lens block is a rectilinear lens block.
A39. The lens array of any of paragraphs A1-A38, wherein the fixture-attached block side and the lensed block side at least one of:
(i) are on opposed sides of the lens block; and
(ii) face away from one another.
A40. The lens array of any of paragraphs A1-A39, wherein the lens array is configured for surface coupling with the DUT.
A41. The lens array of any of paragraphs A1-A40, wherein a corresponding signal path of each electromagnetic signal through the lens block is linear.
A42. The lens array of any of paragraphs A1-A37, wherein the lens block is a prismatic lens block.
A43. The lens array of any of paragraphs A1-A37 and A42, wherein the lens block includes a reflection surface configured to reflect the plurality of electromagnetic signals to convey the plurality of electromagnetic signals between the plurality of fiber optic conduits and the plurality of lenses.
A44. The lens array of any of paragraphs A1-A37 and A42-A43, wherein a corresponding signal path of each electromagnetic signal through the lens block includes at least one reflection within the lens block.
A45. The lens array of any of paragraphs A1-A37 and A42-A44, wherein the fixture-attached block side and the lensed block side are angled relative to one another and/or are not parallel to one another.
A46. The lens array of any of paragraphs A1-A37 and A42-A45, wherein the lens array is configured for edge coupling with the DUT.
B1. A fiber optic fixture, comprising:
a fixture body that defines a lens-receiving surface;
a plurality of fiber optic conduits terminating at the lens-receiving surface; and the lens array of any of paragraphs A1-A46, wherein the fixture-attached block side of the lens block is operatively attached to the lens-receiving surface of the fixture body.
B2. The fiber optic fixture of paragraph B1, wherein the lens block is at least one of: (i) formed on the lens-receiving surface; and
(ii) 3D printed on the lens-receiving surface.
B3. The fiber optic fixture of any of paragraphs B1-B2, wherein the fiber optic fixture further includes a bonding layer selected to increase bond strength between the lens block and the fixture body.
B4. The fiber optic fixture of paragraph B3, wherein the bonding layer defines an adhesive strength between the lens block and the fixture body of at least 0.4 megapascals (mPa), at least 0.45 mPa, at least 0.5 mPa, at least 0.55 mPa, at least 0.6 mPa, at least 0.7 mPa, at least 0.8 mPa, at least 0.9 mPa, or at least 1 mPa.
B5. The fiber optic fixture of any of paragraphs B3-B4, wherein the bonding layer has a bond layer refractive index of at least one of:
(i) at least 1, at least 1.1, at least 1.2, at least 1.3, at least 1.4, at least 1.48, at least 1.49, at least 1.5, at least 1.51, at least 1.52, at least 1.53, at least 1.54, at least 1.6, at least 1.8, at least 2; and
(ii) at most 3, at most 2.8, at most 2.6, at most 2.4, at most 2.2, at most 2, at most 1.8, at most 1.6, at most 1.59, at most 1.58, at most 1.57, at most 1.56, at most 1.55, or at most 1.54.
B6. The fiber optic fixture of any of paragraphs B3-B5, wherein the bonding layer is transparent, or at least substantially transparent, at least one of:
(i) to the plurality of electromagnetic signals; and
(ii) an/the electromagnetic signal frequency of the plurality of electromagnetic signals.
B7. The fiber optic fixture of any of paragraphs B1-B6, wherein the fixture body, the plurality of fiber optic conduits, and the lens array all are formed utilizing a, or a single, 3D printing process.
C1. A probe system, comprising:
a DUT support fixture configured to operatively support a device under test (DUT);
the fiber optic fixture of any of paragraphs B1-B7; and
an electromagnetic signal generation and analysis assembly configured to at least one of provide at least a provided subset of the plurality of electromagnetic signals to a corresponding providing subset of the plurality of fiber optic conduits and receive at least a received subset of the plurality of electromagnetic signals from a corresponding receiving subset of the plurality of fiber optic conduits.
C2. The probe system of paragraph C1, wherein the DUT support fixture is configured to operatively support the DUT in the form of at least one of a singulated DUT and a packaged DUT.
C3. The probe system of any of paragraphs C1-C2, wherein the probe system further includes at least one electrical probe configured to at least one of provide an electric test signal to the DUT, provide an electric power signal to the DUT, and receive an electric resultant signal from the DUT.
C4. The probe system of paragraph C3, wherein the at least one electrical probe forms a portion of the DUT support fixture.
C5. The probe system of any of paragraphs C3-C4, wherein the probe system further includes an electric signal generation and analysis assembly configured to at least one of provide the electric test signal to the at least one electrical probe, provide the electric power signal to the at least one electrical probe; and receive the electric resultant signal from the at least one electrical probe.
C6. The probe system of any of paragraphs C1-C5, wherein the probe system further includes an optical assembly configured to collect an optical image of at least one of the DUT support fixture, the DUT, the fiber optic fixture, and a/the lens block fiducial.
C7. The probe system of any of paragraphs C1-C6, wherein the probe system further includes the DUT, wherein the DUT is supported by the DUT support fixture.
C8. The probe system of paragraph C7, wherein a/the lens block fiducial of the lens block is at least one of positioned along an optical pathway of an/the optical assembly of the probe system and in focus to the optical assembly.
C9. The probe system of any of paragraphs C7-C8, wherein the plurality of lenses of the lens block is optically aligned with the plurality of optical devices of the DUT.
C10. The probe system of paragraph C9, wherein a/the block alignment structure of the lens block is operatively engaged with a/the DUT alignment structure of the DUT.
C11. The probe system of any of paragraphs C1-C10, wherein the probe system further includes a translation structure configured to at least one of translate and rotate the fiber optic fixture and the DUT support fixture relative to one another.
D1. A method of forming a fiber optic fixture of a probe system, the method comprising: 3D printing at least a region of the lens array of any of paragraphs A1-A46.
D2. The method of paragraph D1, wherein the 3D printing includes printing an entirety of the lens array on a lens-receiving surface of a fixture body of the fiber optic fixture, wherein the fiber optic fixture includes a plurality of fiber optic conduits that terminate at the lens-receiving surface, and further wherein the 3D printing includes 3D printing such that a relative orientation of the plurality of lenses corresponds to a relative orientation of a terminal end of the plurality of fiber optic conduits on the lens-receiving surface.
D3. The method of any of paragraphs D1-D2, wherein the 3D printing includes 3D printing the lens array as a single, monolithic, or unitary structure.
D4. The method of any of paragraphs D1-D3, wherein the 3D printing includes 3D printing the lens array from a/the, or a single, lens block material.
D5. The method of paragraph D1, wherein the 3D printing includes 3D printing the plurality of lenses on a previously formed lens block of the lens array.
D6. The method of paragraph D5, wherein at least one of:
(i) the lens block is a glass lens block; and
(ii) the plurality of lenses is a plurality of polymeric lenses.
D7. The method of any of paragraphs D5-D6, wherein the method further includes operatively attaching the lens block to the fixture body, optionally utilizing a bonding layer.
D8. The method of any of paragraphs D1-D7, wherein the method further includes 3D printing at least one of the fixture body and the plurality of fiber optic conduits.
D9. The method of any of paragraphs D1-D8, wherein the method further includes 3D printing a bonding layer between the fixture body and the lens block.
D10. The method of any of paragraphs D1-D9, wherein the fixture body includes any suitable structure, function, and/or feature of any of the fixture bodies of any of paragraphs B1-B7.

### INDUSTRIAL APPLICABILITY

The lens blocks, fiber optic fixtures, probe systems, and methods disclosed herein are applicable to the semiconductor manufacturing and test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A lens array configured to convey a plurality of electromagnetic signals between a plurality of fiber optic conduits of a fiber optic fixture and a plurality of optical devices of a device under test (DUT), the lens array comprising:
a single lens block that defines:
(i) a fixture-attached block side, which is configured to face toward, and be operatively attached to, a fixture body of the fiber optic fixture; and
(ii) a lensed block side, which differs from the fixture-attached block side; and
a plurality of lenses defined on the lensed block side.

2. The lens array of claim 1, wherein the plurality of lenses is defined solely on the lensed block side.

3. The lens array of claim 1, wherein a given lens of the plurality of lenses defines a corresponding signal path between the fixture-attached block side and the given lens, and further wherein the corresponding signal path extends solely within a lens block material of the lens block between the fixture-attached block side and the given lens.

4. The lens array of claim 1, wherein each lens of the plurality of lenses defines a corresponding lens shape, wherein the corresponding lens shape is at least substantially constant for each lens of the plurality of lenses.

5. The lens array of claim 1, wherein each lens of the plurality of lenses defines a corresponding lens shape, wherein the corresponding lens shape of at least one lens of the plurality of lenses differs from the corresponding lens shape of at least one other lens of the plurality of lenses.

6. The lens array of claim 1, wherein the lensed block side defines a lensed block side face, wherein at least one lens of the plurality of lenses projects from the lensed block side face by a corresponding lens projection distance.

7. The lens array of claim 1, wherein the lensed block side defines a lensed block side face, wherein at least one lens of the plurality of lenses is recessed from the lensed block side face and into the lens block by a corresponding lens recess distance.

8. The lens array of claim 1, wherein a lens block material of the lens block is at least substantially transparent at least one of:
(i) to the plurality of electromagnetic signals; and
(ii) at an electromagnetic signal frequency of the plurality of electromagnetic signals.

9. The lens array of claim 1, wherein the lens block includes a lens block fiducial configured to be visible to an optical assembly of a probe system that includes the lens array, wherein the lens block fiducial includes at least one of:
(i) a first lens block fiducial configured to be visible to the optical assembly from a first direction;
(ii) a second lens block fiducial configured to be visible to the optical assembly from a second direction, which is at least substantially perpendicular to the first direction; and
(iii) a third lens block fiducial configured to be visible to the optical assembly from a third direction, which is at least substantially perpendicular to the first direction and the second direction.

10. The lens array of claim 1, wherein the lens block defines a block alignment structure shaped to operatively engage with a corresponding DUT alignment structure of the DUT to facilitate optical alignment between the plurality of lenses of the lens array and the plurality of optical devices of the DUT.

11. The lens array of claim 10, wherein, when the block alignment structure is operatively engaged with the DUT alignment structure, the block alignment structure and the DUT alignment structure precisely position the lens array and the DUT relative to one another in three orthogonal directions.

12. The lens array of claim 1, wherein a lens block material of the lens block fully defines both the single lens block and the plurality of lenses.

13. The lens array of claim 1, wherein a lens material, which differs from a lens block material of the lens block, defines the plurality of lenses.

14. The lens array of claim 1, wherein the fixture-attached block side and the lensed block side at least one of:
(i) are on opposed sides of the lens block; and
(ii) face away from one another.

15. The lens array of claim 1, wherein the lens array is configured for surface coupling with the DUT.

16. The lens array of claim 1, wherein a corresponding signal path of each electromagnetic signal through the lens block is linear.

17. The lens array of claim 1, wherein the lens array is configured for edge coupling with the DUT.

18. The lens array of claim 1, wherein a corresponding signal path of each electromagnetic signal through the lens block includes at least one reflection within the lens block.

19. A fiber optic fixture, comprising:
a fixture body that defines a lens-receiving surface;
a plurality of fiber optic conduits terminating at the lens-receiving surface; and
the lens array of claim 1, wherein the fixture-attached block side of the lens block is operatively attached to the lens-receiving surface of the fixture body.

20. A probe system, comprising:
a DUT support fixture configured to operatively support a device under test (DUT);
the fiber optic fixture of claim 19; and
an electromagnetic signal generation and analysis assembly configured to at least one of provide at least a provided subset of the plurality of electromagnetic signals to a corresponding providing subset of the plurality of fiber optic conduits and receive at least a received subset of the plurality of electromagnetic signals from a corresponding receiving subset of the plurality of fiber optic conduits.

21. A method of forming a fiber optic fixture of a probe system, the method comprising: 3D printing at least a region of the lens array of claim 1.
